(19) United States
(12) Patent Application Publication
(10) Pub. No.: US 2015/0089043 A1
(43) Pub. Date: Mar. 26, 2015

(54) User Device Monitoring

(71) Applicant: Lingua Next Technologies Pvt. Ltd., Pune (IN)

(72) Inventor: Rajeevlochan Phadke, Pune (IN)

(73) Assignee: Lingua Next Technologies Pvt. Ltd., Pune (IN)

(21) Appl. No.: 14/032,612

(22) Filed: Sep. 20, 2013

(51) Int. Cl. H04L 12/26

(52) U.S. Cl. CPC H04L 43/04
USPC 709/224

(57) ABSTRACT

A method for monitoring a user device is disclosed. The method includes intercepting text of one or more applications being displayed on the user device. The method further includes generating one or more first patterns from the intercepted text. Thereafter, the one or more first patterns are compared with one or more pre-stored second patterns. Based on the comparison, capture of information is triggered and the captured information is sent to a server for generating alerts.

### TECHNICAL FIELD

The presently disclosed embodiments relate to monitoring of user devices. More particularly, the presently disclosed embodiments relate to methods and systems for monitoring user devices in a network to generate various alerts.

### BACKGROUND

In today's Internet age, more and more information is available to users. In an enterprise, users have access to various enterprise applications, external web-sites (such as Gmail, yahoo, etc.), social networking sites (such as Facebook, Google+) and search engines (such as google, bing, etc.). Having access to so much information, the users may access information for which they are not authorized. In such a scenario, it is important for the enterprise to monitor the information being accessed by the users within the enterprise.

Various applications are available for monitoring the information being accessed by the users. However, such applications can only block some specific sites on the basis of pre-defined block lists, thereby not providing complete protection against unauthorised access to the information. Further, such applications perform the monitoring of the information being accessed by the users periodically. The information is monitored after pre-defined intervals to create a log of all the information accessed by the user in that period. An analysis is then performed on such a huge collection of information to figure out any unauthorised access. Such an analysis is very time-consuming and does not provide any alert at the time when the unauthorized access is actually being done by the users. Further, there are various applications which perform continuous monitoring of the information being accessed by the users. However, such applications only block the information that is accessed by the users but do not generate any alerts to notify appropriate officials about the unauthorised access. Such applications also do not provide any data to the officials to show what unauthorised information was accessed by the user.

### SUMMARY

According to embodiments illustrated herein, there is provided a method for monitoring a user device in a network. The method includes intercepting text of one or more applications being displayed on the user device. The method further includes generating one or more first patterns from the intercepted text using at least one of a regular expression analysis and a language grammar analysis. Thereafter, the one or more first patterns are compared with one or more pre-stored second patterns. Based on the comparison, capture of information is triggered and the captured information is sent to a server for generating one or more alerts.

According to embodiments illustrated herein, there is provided a system for monitoring a user device in a network. The system includes a text intercept module configured to intercept text of one or more applications being displayed on the user device. The system further includes an analysis module configured to generate one or more first patterns from the intercepted text using at least one of a regular expression analysis and a language grammar analysis. The system further includes a trigger module configured to compare the one or more first patterns with one or more pre-stored second patterns. The trigger module is also configured to trigger capture of information based on the comparison. The system further includes a transceiver module configured to send the captured information to a server for generating one or more alerts.

According to embodiments illustrated herein, there is provided a computer program product. The computer program product includes a non-transitory computer usable medium having a computer readable program code. The computer readable program code is used by the computer to intercept text of one or more applications being displayed on the user device. The computer readable program code is further used to generate one or more first patterns from the intercepted text using at least one of a regular expression analysis and a language grammar analysis. The computer readable program code is further used to compare the one or more first patterns with one or more pre-stored second patterns. The computer readable program code is further used to trigger capture of information based on the comparison. The computer readable program code is further used to send the captured information to the server for generating one or more alerts.

### BRIEF DESCRIPTION OF DRAWINGS

The accompanying drawings illustrate various embodiments of systems, methods, and/or other aspects of the invention. Any person having ordinary skill in the art will appreciate that the illustrated element boundaries (such as boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment in which the present disclosure may be implemented;

FIG. 2 is a block diagram illustrating the user device, in accordance with an embodiment; and

FIG. 3 is a flow diagram illustrating a method for monitoring a user device in a network, in accordance with an embodiment.

### DETAILED DESCRIPTION

The present disclosure is best understood with reference to the detailed figures and descriptions set forth herein. Various embodiments are discussed below with reference to the figures. However, those skilled in the art will readily appreciate that the detailed descriptions given herein with respect to the figures are simply for explanatory purposes, as systems and methods may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

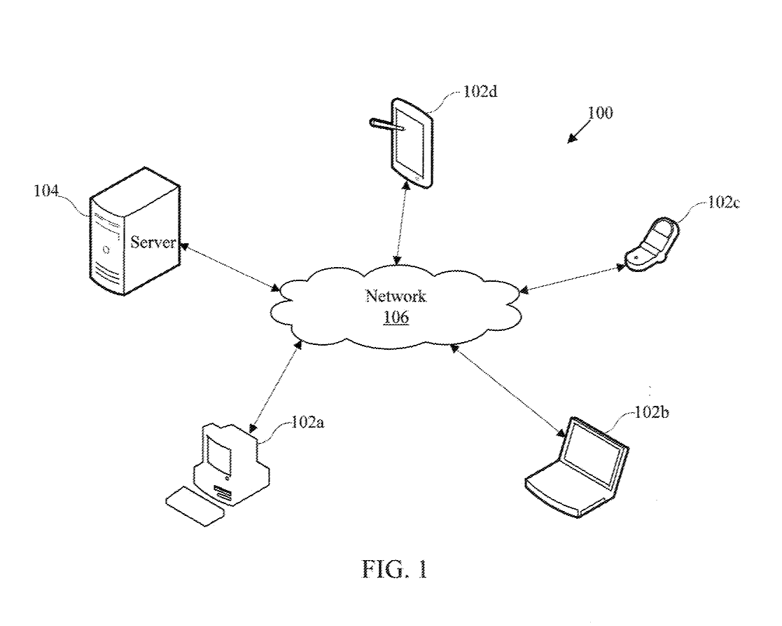

FIG. 1 is a block diagram illustrating a system environment 100 in which the present disclosure may be implemented.

The system environment 100 includes a plurality of user devices 102a, 102b, 102c and 102d. For purposes of the ongoing description, embodiments of the present disclosure have been described for a user device 102, which may refer to one of the user devices 102a, 102b, 102c and 102d. It may be appreciated that the disclosed embodiments are applicable to the user devices 102a, 102b, 102c, and 102d. In an embodiment, the user device 102a may correspond to a desktop computer, the user device 102b may correspond to a laptop, the user device 102c may correspond to a smart phone, and the user device 102d may correspond to a tablet computer. In another embodiment, the user devices 102a, 102b, 102c, and 102d may correspond to the same genre of user devices. For example, each of the user devices 102a, 102b, 102c, and 102d may correspond to a desktop computer, or a laptop, or a smart phone or a tablet computer. The system environment 100 further includes a server 104. The system environment 100 also includes a network 106. The user devices 102a, 102b, 102c and 102d communicate with the server 104 through the network 106.

The user device 102 may be any device capable of receiving an input from a user on a user interface displayed on a screen. Examples of the user device 102 may include, but are not limited to, a laptop, a tablet computer, a desktop computer, and other such devices having a display screen that displays a user interface. The user device 102 intercepts text of one or more applications being displayed on the screen. Thereafter, the user device 102 generates one or more first patterns from the intercepted text. In an embodiment, the user device 102 performs a regular expression analysis on the intercepted text to generate the one or more patterns. In another embodiment, the user device 102 performs a language grammar analysis on the intercepted text to generate the one or more patterns.

After generating the one or more patterns, the user device 102 compares the one or more first patterns with one or more pre-stored second patterns. The pre-stored one or more patterns are referred to as one or more second patterns hereinafter. In an embodiment, the one or more second patterns are pre-stored by an official or an administrator. Therefore, the official or the administrator can modify the one or more second patterns on a need basis. Based on the comparison, the user device 102 triggers capture of information. In an embodiment, the user device 102 triggers capture of information when the one or more first patterns matches with the one or more second patterns. The user device 102 then sends the captured information to the server 104 for generating alerts. In an embodiment, the capture of the information may include taking one or more snapshots of the one or more applications at pre-defined intervals. In another embodiment, the capture of information may include recording a video of the one or more applications. In yet another embodiment, the capture of information may include capturing application name, IP address, application URL, time of accessing an application, or the user device 102 details.

In an embodiment, the user device 102 performs all the above mentioned tasks. It will be appreciated by a person having ordinary skill in the art that in the presently disclosed embodiments, the computing power of the user device 102 is utilized in order to restrict access. It will also be appreciated that using the user device 102, the computing power of the server 104 can be saved in addition to significantly reduced bandwidth usage (due to reduced data transfer between the user device 102 and the server 104). Further, the analysis of the intercepted text is done preferably at each of the user devices 102, and the captured information is sent to the server 104 only when some sort of unauthorised access is encountered. This does not overload the server 104, thereby improving the response time. In another embodiment, all the above mentioned tasks may be performed by the server 104.

The server 104 receives the captured information from the user device 102. On receiving the captured information, the server 104 generates alerts to notify appropriate officials about an unauthorized access to the one or more applications. The alerts may include, but are not limited to, sending an email, sending a text message (SMS), sending a multi-media message (MMS), sending a pop-up message, or making one or more phone calls. The unauthorized access may include, but is not limited to, a user copying information from the one or more applications and sending out the information through email or social network sites, a user searching for text on the one or more applications that appears under “watch text list”, a user receiving any sort of unauthorized information, a user navigating to dangerous sites or connecting with dangerous people, unauthorized access and/or execution of application, or copying and/or deletion of documents or data, copying of configuration files, etc.

The server 104 also displays the captured information to the officials for their reference. The server 104 also performs certain actions on the user device 102 based on the information received. The actions may include, but are not limited to, locking a keyboard, locking a mouse, making a power button unresponsive, or taking a picture of the user using a webcam of the user device 102. Further, based on the information received from the user device 102, the server 104 updates the one or more second patterns and sends the one or more second patterns to the user device 102.

The server 104 may be any dedicated hardware capable of performing communication with the user device 102. Examples of the server 104 may include a computer system running on a server operating system, and other devices that may be present in a data center or in any server farm hosted by a specific client. The operating system may be ‘Unix’, ‘Windows’, ‘Linux’, ‘Android’, ‘iOS’, or any other server operating system. Although one server 104 has been shown in FIG. 1, it may be appreciated that the disclosed embodiments can be extended to a large number and variety of servers.

The network 106 corresponds to a medium through which various components (the user devices 102a, 102b, 102c, and 102d and the server 104) of the system environment 100 communicate with each other. Examples of the network 106 may include, but are not limited to, a television broadcasting system, an Internet Protocol television (IPTV) network, the Internet, GSM/CDMA mobile network (2G, 3G, 4G, 5G and the like), a Wireless Fidelity (Wi-Fi) network, a Wireless Area Network (WAN), a Local Area Network (LAN), a telephone line (POTS), or a Metropolitan Area Network (MAN). Various devices in the system environment 100 can connect to the communication network 106, in accordance with various wired and wireless communication protocols, such as Transmission Control Protocol and Internet Protocol (TCP/IP), User Datagram Protocol (UDP), and 2G, 3G, or 4G communication protocols.

For one ordinarily skilled in the art, it is understood that the steps implemented by the elements described above are exemplary in nature and are simply used to facilitate the description of FIG. 1. The steps described above may be implemented by any of the elements as shown in the figure. Accordingly, it is clear that that the invention is not limited to the embodiment described herein.

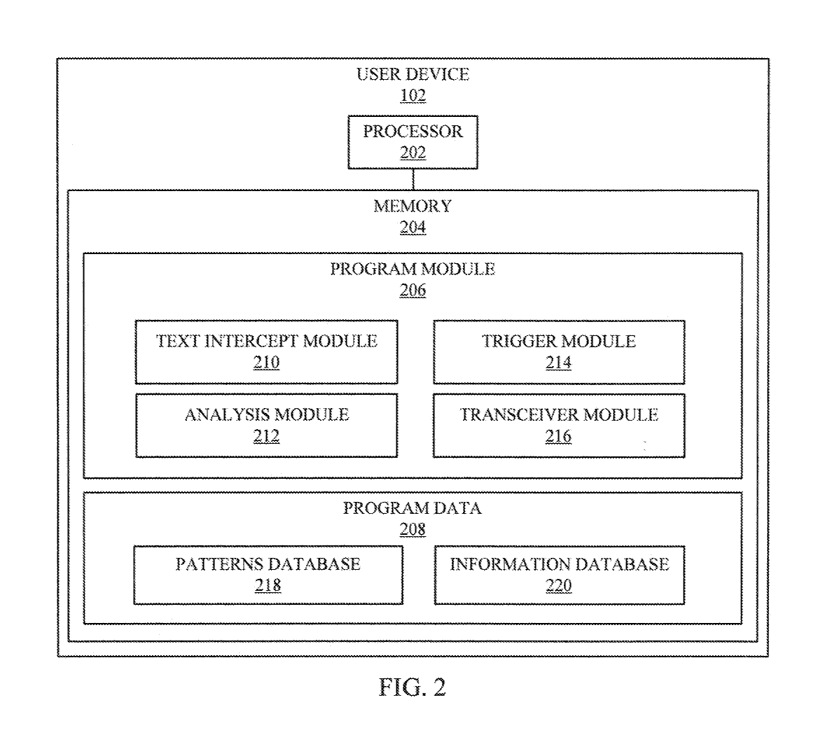

FIG. 2 shows a block diagram illustrating the user device 102, in accordance with an embodiment. To describe the block diagram illustrated in FIG. 2, references will be made to FIG. 1, although it will be apparent to those skilled in the art that the implementation details of the block diagram can be applicable to any other embodiment of the present invention.

The user device 102 includes a processor 202 coupled to a memory 204. The memory 204 includes a program module 206 and a program data 208. The memory 204 can be, but is not limited to, a random access memory (RAM), a read only memory (ROM), a hard disk drive (HDD), and a secure digital (SD) card. The processor 202 executes instructions stored in the program module 206. The program data 208 stores the data to be accessed/provided by the processor 202. The processor 202 can be realized through a number of processor technologies known in the art. Examples of the processor 202 include, but are not limited to, X86 processor, RISC processor, ASIC processor, CISC processor, or any other processor. The program module 206 includes a text intercept module 210, an analysis module 212, a trigger module 214, and a transceiver module 216.

The program data 208 includes a patterns database 218 and an information database 220. The patterns database 218 stores one or more first patterns generated from the intercepted text. The patterns database 218 also stores one or more second patterns (e.g., reference patterns).

A pattern (e.g., any of the one or more first patterns or the one or more second patterns) includes information on user activities performed over a time. In an embodiment, appearance/display and use of various keywords (and/or variations of the keywords) at different locations on the screen of the user device 102 and/or in different applications running on the user device 102 at various times can be considered as the first patterns. The variations of the keywords include synonyms, truncated forms, gerund forms, verbs, nouns, spelling corrected versions, abbreviations, and the like. Thus, the first patterns can be based on various parameters like keywords, time, location on the screen, and associated applications.

In an embodiment, the one or more second patterns may be pre-stored by an official or an administrator at of the user device 102. In another embodiment, the one or more second patterns may be periodically sent by the server 104. The information database 220 stores captured information based on the comparison of the one or more first patterns with the one or more second patterns. In an embodiment, the one or more first patterns and the one or more second patterns may be stored together in the patterns database 218. In another embodiment, the one or more first patterns and the one or more second patterns may be stored separately in different databases. In yet another embodiment, the one or more first patterns, the one or more second patterns, and the captured information may all be stored in the same database.

The text intercept module 210 intercepts text of one or more applications being displayed on the user device 102. The one or more applications may include, but are not limited to, web applications, desktop applications, social networking sites, internal applications of an enterprise, emails, etc. The text intercept module 210 also intercepts print and file output stream of the one or more applications. In an embodiment, the text intercept module 210 may intercept the text using an API (Application Program Interface) interception. In another embodiment, the text intercept module 210 may use any text intercepting technology known in the art.

The analysis module 212 generates one or more patterns from the intercepted text. The one or more patterns are referred to as one or more first patterns hereinafter. In an embodiment, the analysis module 212 generates the one or more first patterns using a regular expression analysis. A regular expression is a specific pattern that provides concise and flexible means to match (specify and recognize) strings of text, such as particular characters, words or patterns of characters. In another embodiment, the analysis module 212 generates the one or more first patterns using a language grammar analysis. In an embodiment, the analysis module 212 may store the one or more first patterns in the patterns database 218.

The trigger module 214 compares the one or more first patterns with pre-stored one or more patterns. In an embodiment, the one or more second patterns may be expressions that specify a set of strings, such as particular characters, words or patterns of characters, which need to be denied user access. In an embodiment, the one or more second patterns may be pre-stored by an official or an administrator of the user device 102. In another embodiment, the one or more second patterns may be periodically sent by the server 104. Further, based on the comparison, the trigger module 214 triggers capture of information. In an embodiment, the trigger module 214 triggers capture of information if the one or more first patterns matches with the one or more second patterns. The captured information is then stored by the trigger module 214 in the information database 220. In an embodiment, the capture of information may correspond to taking one or more snapshots of the one or more applications at pre-defined intervals. For example, the trigger module 214 may capture the snapshots of the one or more applications at fixed time intervals (say every 2 seconds) at the time of trigger of capture of information, 2 minutes before the trigger of information capture and 2 minutes after the trigger of information capture. It may be noted that the time intervals (2 seconds and 2 minutes) have been mentioned only for exemplary purposes. However, other ranges of time intervals can be considered without departing from the scope of the disclosure.

In an embodiment, the trigger module 214 keeps storing the text displayed on the screen of the user device 102 all the time. The text is stored in the information database 220 with corresponding timestamp. This text will be captured when the trigger module 214 triggers the capture. For example, the trigger module 214 captures the text displayed on the screen 2 minutes before the trigger based on the timestamp of the text.

In case of capturing the information on the screen after 2 minutes of the trigger, the trigger module 214 may capture the snapshots of the one or more applications.

In another embodiment, the capture of information may correspond to recording a video of the one or more applications. For example, the video may be recorded at the time of trigger of capture of information, 2 minutes before the trigger of information capture and 2 minutes after the trigger of information capture. It may be noted that the time intervals (2 minutes) have been mentioned only for exemplary purposes. However, other ranges of time intervals can be considered without departing from the scope of the disclosure. In yet another embodiment, the capture of information may correspond to capturing application name, IP address, application URL, time of accessing an application, or user device details. Once the information is captured, the trigger module 214 sends the captured information to the transceiver module 216.

The transceiver module 216 sends the captured information to the server 104. On receiving the captured information, the server 104 generates alerts to notify appropriate officials about an unauthorized access to the one or more applications. The alerts may include, but are not limited to, sending an email, sending a text message (SMS), sending a multi-media message (MMS), sending a pop-up message, or making one or more phone calls. The unauthorized access may include, but is not limited to, a user copying information from the one or more applications and sending out the information through email or social network sites, a user searching for text on the one or more applications that appears under “watch text list”, a user receiving any sort of unauthorized information, a user navigating to dangerous sites or connecting with dangerous people, etc.

The server 104 also displays the captured information to the officials for their reference. The server 104 also performs certain actions on the user device 102 based on the information received. The actions may include, but are not limited to, locking a keyboard, locking a mouse, making a power button unresponsive, or taking a picture of the user using a webcam of the user device 102. Further, based on the information received from the user device 102, the server 104 updates the one or more second patterns and sends the one or more second patterns to the transceiver module 216. The transceiver module 216 stores the one or more second patterns in the patterns database 218.

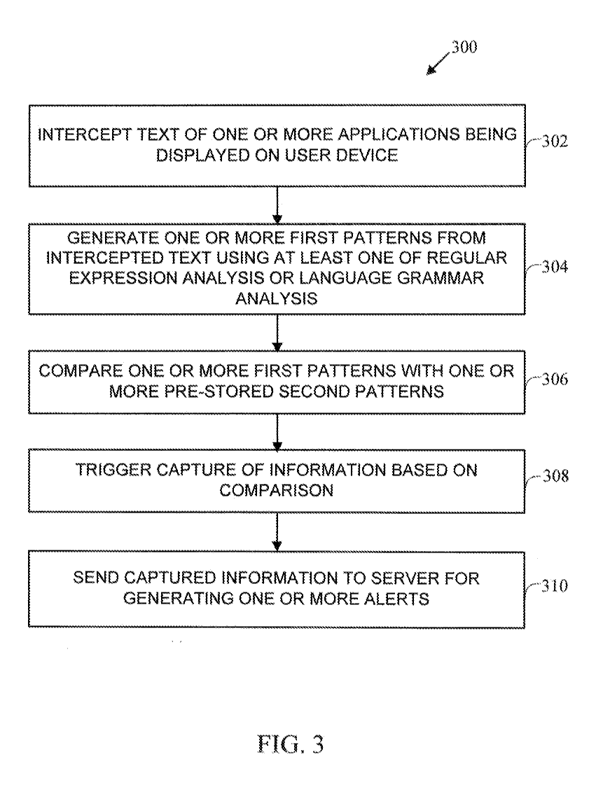

FIG. 3 is a flow diagram 300 illustrating a method for monitoring the user device 102 in a network 106, in accordance with one embodiment.

At step 302, text of one or more applications being displayed on the user device 102 is intercepted. The one or more applications may include, but are not limited to, web applications, desktop applications, social networking sites, internal applications of an enterprise, emails, etc. The print and file output stream of the one or more applications is also intercepted. In an embodiment, the text may be intercepted using an API (Application Program Interface) interception. In another embodiment, the text may be intercepted using any text intercepting technology known in the art.

At step 304, one or more first patterns are generated from the intercepted text. In an embodiment, the one or more first patterns are generated using a regular expression analysis. In another embodiment, the one or more first patterns are generated using a language grammar analysis.

At step 306, the one or more first patterns are compared with pre-stored one or more second patterns. It may be noted that any known means for comparing can be used.

At step 308, capture of information is triggered based on the comparison. In an embodiment, the capture of information is triggered if the one or more first patterns match with the one or more second patterns. The captured information is stored in the information database 220. In an embodiment, the capture of information may correspond to taking one or more snapshots of the one or more applications at pre-defined intervals. For example, the snapshots of the one or more applications may be captured at fixed time intervals (say every 2 seconds) at the time of trigger of capture of information, 2 minutes before the trigger of information capture and 2 minutes after the trigger of information capture. It may be noted that the time intervals (2 seconds and 2 minutes) have been mentioned only for exemplary purposes. However, other ranges of time intervals can be considered without departing from the scope of the disclosure.

In another embodiment, the capture of information may correspond to recording a video of the one or more applications. For example, the video may be recorded at the time of trigger of capture of information, 2 minutes before the trigger of information capture and 2 minutes after the trigger of information capture. It may be noted that the time intervals (2 minutes) have been mentioned only for exemplary purposes. However, other range of time interval can be considered without departing from the scope of the disclosure. In yet another embodiment, the capture of information may correspond to capturing application name, IP address, application URL, time of accessing an application, or user device details.

At step 310, the captured information is sent to the server 104. On receiving the captured information, the server 104 generates alerts to notify appropriate officials about an unauthorized access to the one or more applications. The alerts may include, but are not limited to, sending an email, sending a text message (SMS), sending a multi-media message (MMS), sending a pop-up message, or making one or more phone calls. The unauthorized access may include, but are not limited to, a user copying information from the one or more applications and sending out the information through email or social network sites, a user searching for text on the one or more applications that appears under “watch text list”, a user receiving any sort of unauthorized information, a user navigating to dangerous sites or connecting with dangerous people, unauthorized access and/or execution of application, or copying and/or deletion of documents or data, copying of configuration files, etc.

The server 104 also displays the captured information to the officials for their reference. The server 104 also performs certain actions on the user device 102 based on the information received. The actions may include, but are not limited to, locking a keyboard, locking a mouse, making a power button unresponsive, or taking a picture of the user using a webcam of the user device 102. Further, based on the information received from the user device 102, the server 104 updates the one or more second patterns and sends the one or more second patterns to the user device 102. The user device 102 stores the one or more second patterns in the patterns database 218.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, and a display unit. The computer further comprises a microprocessor. The microprocessor is connected to a communication bus. The computer also includes a memory. The memory may be a Random Access Memory (RAM) or a Read Only Memory (ROM). The computer system further comprises a storage device, which may be a hard-disk drive or a removable storage drive, such as a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, ‘VB.Net’, ‘C#.Net’, ‘ASP.Net’, ‘Java’, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Windows’, ‘Unix’, ‘DOS’, ‘Android’, ‘Symbian’, ‘iOS’, and ‘Linux’.

The programmable instructions can be stored and transmitted on a non-transitory computer-readable medium. The disclosure can also be embodied in a computer program product comprising a non-transitory computer-readable medium, or with any product capable of implementing the above methods and systems, or the numerous possible variations thereof.

The system, method and computer program product, as described above, have numerous advantages. Some of these advantages may include, but are not limited to, faster and accurate notification to appropriate officials about an unauthorised access to one or more applications. Since the user device captures the information at the time of the unauthorised access, the accuracy and speed of notifying the officials is much higher than the conventional techniques. Further, since the information is captured at the time of the unauthorised access, there is no need for periodic collection of the information that leads to accumulation of huge data at the user device.

Further, since the alerts are generated based on textual information, such information can be used to index any archived information for easier search capabilities. Also, the response time of the system is very fast since the analysis of the intercepted text is done at each of the user devices, and the captured information is sent to the server only when some sort of unauthorised access is encountered. This does not overload the server, thereby increasing the response time.

Various embodiments of the methods and systems for monitoring user devices have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art which are also intended to be encompassed by the following claims.

What is claimed is:

1. A method for monitoring a user device in a network, the method comprising:
intercepting text of one or more applications being displayed on the user device;
generating one or more first patterns from the intercepted text using at least one of a regular expression analysis and a language grammar analysis;
comparing the one or more first patterns with one or more pre-stored second patterns;
triggering capture of information based on the comparison; and
sending the captured information to a server for generating one or more alerts, wherein the above steps are performed by a microprocessor.

2. The method of claim 1, wherein the capture of information is triggered if the one or more first patterns matches with the one or more second patterns.

3. The method of claim 1, wherein the capturing of information comprises taking one or more snapshots of the one or more applications at pre-defined intervals.

4. The method of claim 1, wherein the capturing of information comprises recording a video of the one or more applications.

5. The method of claim 1, wherein the captured information comprises at least one of: application name, IP address, application URL, time of accessing an application, and user device details.

6. The method of claim 1, wherein the one or more alerts comprises at least of: an email, a text message, a multi-media message (MMS), a pop-up message, and one or more phone calls.

7. The method of claim 1 further comprising performing one or more actions on the user device, wherein the one or more actions comprise at least one of: locking a keyboard, locking a mouse, making a power button unresponsive, and taking a picture of the user using a webcam of the user device.

8. The method of claim 1 further comprising updating the one or more second patterns based on the captured information.

9. A system for monitoring a user device in a network, the system comprising:
a memory comprising one or more program instructions modules, wherein the one or more program instructions modules comprises:
a text intercept module configured to intercept text of one or more applications being displayed on the user device,
an analysis module configured to generate one or more first patterns from the intercepted text using at least one of a regular expression analysis and a language grammar analysis,
a trigger module configured to:
compare the one or more first patterns with one or more pre-stored second patterns; and
trigger capture of information based on the comparison;
a transceiver module configured to send the captured information to a server for generating one or more alerts; and
a microprocessor operable to execute the one or more program instruction modules.

10. The system of claim 9, wherein the transceiver module is further configured to receive the one or more second patterns from the server.

11. The system of claim 9, wherein the trigger module is configured to trigger capture of information if the one or more first patterns matches with the one or more second patterns.

12. The system of claim 11, wherein the trigger module is configured to perform one or more actions on the user device.

13. The system of claim 12, wherein the trigger module is configured to perform at least one of: locking a keyboard, locking a mouse, making a power button unresponsive, and taking a picture of the user using a webcam of the user device.

14. The system of claim 9, wherein the memory further comprises a pattern database for storing the one or more first patterns and the one or more second patterns.

15. The system of claim 9, wherein the memory further comprises an information database for storing the captured information.

16. A computer program product for use with a computer, the computer program product comprising a non-transitory computer readable medium having a computer readable program code embodied therein for monitoring a user device in a network, the computer readable program code when used by the computer enabling communication with a server over a network, the computer readable program code being used by the computer to:
intercept text of one or more applications being displayed on the user device;
generate one or more first patterns from the intercepted text using at least one of a regular expression analysis and a language grammar analysis;
compare the one or more first patterns with one or more pre-stored second patterns;
trigger capture of information based on the comparison; and
send the captured information to the server for generating one or more alerts.
